(19) United States
(12) Patent Application Publication
(10) Pub. No.: US 2020/0304308 A1
(43) Pub. Date: Sep. 24, 2020

(54) METHOD FOR PROVIDING A PROOF-OF-RETRIEVABILITY

(71) Applicants: NEC LABORATORIES EUROPE GMBH, Heidelberg (DE); UNIVERSITÄT MANNHEIM, Mannheim (DE)

(72) Inventors: Frederik Armknecht, Worms (DE); Ghassan Karame, Heidelberg (DE)

(21) Appl. No.: 16/088,086

(22) PCT Filed: Apr. 8, 2016
(86) PCT No.: PCT/EP2016/057699

§ 371 Date: Sep. 25, 2018

(51) Int. Cl. H04L 9/32

(52) U.S. Cl. CPC H04L 9/3218; H04L 9/3236; H04L 2209/56; H04L 2209/38; H04L 2209/08

(57) ABSTRACT

A method for providing a proof-of-retrievability (POR) to a client for data stored on a storage entity includes the steps of: a) Encoding, by the client, data to be stored on the storage entity; b) Exchanging credentials between the storage entity, the client, and an auditor; c) Committing, by the client, to the encoded information using data identification information; d) Storing the encoded data on the storage entity together with the data identification information e) Computing, by the auditor, logging information for the stored data by performing one or more POR between the auditor and the storage entity, wherein for sampling randomness for the POR a public source of unpredictable randomness is used; Verifying, by the auditor, the computed logging information; and g) Verifying, by the client, the verified logging information of the auditor in a single batch verification procedure.

### CROSS-REFERENCE TO PRIOR APPLICATIONS

This application is a U.S. National Stage Application under 35 U.S.C. § 371 of International Application No. PCT/EP2016/057699 filed on Apr. 8, 2016. The International Application was published in English on Oct. 12, 2017, as WO 2017/174141 A1 under PCT Article 21

### FIELD

The present invention relates to a method for providing a proof-of-retrievability, ‘POR’, to a client for data stored on a storage entity.

### BACKGROUND

Proofs of Retrievability, ‘POR’, are cryptographic proofs, e.g. shown in the non-patent literature of SHACHAM, H., and WATERS, B. Compact Proofs of Retrievability, in ASIACRYPT (2008), pp. 90-107, enabling a cloud provider to prove that a user can retrieve his file in its entirety. POR can be frequently executed by the user to ensure that their files stored on the cloud can be fully retrieved at any point in time. To conduct and verify POR, users need to be equipped with devices that have network access, and that can tolerate the (non-negligible) computational overhead incurred by the verification process.

In the non-patent literature of Frederik Armknecht, Jens-Matthias Bohli, Ghassan Karame, Zongren Liu, Christian Reuter, Outsourced Proofs of Retrievability In Proceedings of the ACM Conference on Computer and Communications Security (ACM CCS), Arizona, USA, 2014, so-called outsourced Proofs of Retrievabilty are described in which users can task an external auditor to perform and verify a POR with a cloud provider. However, the inventors have recognized that, conventional secure publicly verifiable POR schemes cannot be transformed into an OPOR (outsourced POR) in general or only with major modifications.

### SUMMARY

An embodiment of the present invention provides a method for providing a proof-of-retrievability (POR), to a client, for data stored on a storage entity, which includes the steps of: a) Encoding, by the client, data to be stored on the storage entity; b) Exchanging credentials between the storage entity, the client, and an auditor; c) Committing, by the client, to the encoded information using data identification information; d) Storing the encoded data on the storage entity together with the data identification information; e) Computing, by the auditor, logging information for the stored data by performing one or more POR between the auditor and the storage entity, wherein for sampling randomness for the POR a public source of unpredictable randomness is used; Verifying, by the auditor, the computed logging information; and g) Verifying, by the client, the verified logging information of the auditor in a single batch verification procedure.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows steps of a method according to an embodiment of the present invention;

FIG. 2 shows steps of a method according to a further embodiment of the present invention; and

FIG. 3 shows steps of method according to a further embodiment of the present invention.

### DETAILED DESCRIPTION

Embodiments of the present invention provide a secure outsourced/delegable POR scheme being transformed from any secure publicly verifiable POR scheme with only minor modifications, in particular with minimal user interaction

One of the problems addressed by embodiments of the present invention is that conventionally large-scale adoption of POR by cloud users is hindered, since many users increasingly rely on portable devices that have limited computational capacity, or might not always have network access.

Embodiments of the present invention provide enhanced trust in cloud storage.

In an embodiment, the present invention provides a method for providing a proof-of-retrievability, ‘POR’, to a client, for data stored on a storage entity, performed in a memory of one or more computing devices, including the steps of:
a) Encoding, by the client, data to be stored on the storage entity,
b) Exchanging credentials between the storage entity, the client and an auditing entity,
c) Committing, by the client, to the encoded information using data identification information,
d) Storing the encoded data on the storage entity together with the data identification information,
e) Computing, by the auditing entity, logging information for the stored data by performing one or more POR between the auditing entity and the storage entity, wherein for sampling randomness for the POR a public source of unpredictable randomness is used,
f) Verifying, by the auditing entity, the computed logging information, and
g) Verifying, by the client, the verified logging information of the auditing entity in a single batch verification procedure.

In a further embodiment, the present invention provides a system for providing a proof-of-retrievability, ‘POR’, for data to a client, the system including a storage entity for storing the data of the client, and an auditing entity In this embodiment, the client is adapted:
to encode data to be stored on the storage entity,
to exchange credentials with the storage entity and the auditing entity,
to commit to the encoded information using data identification information,
to initialize storing the encoded data on the storage entity together with the data identification information, and
to verify verified logging information of the auditing entity in a single batch verification procedure,
   Also, the storage entity is adapted:
to exchange credentials with the client and the auditing entity,
to store the encoded data together with data identification information, and
to perform one or more POR with the auditing entity,
   Further, the auditing entity is adapted:
to exchange credentials with the storage entity and the client,
to compute logging information for the stored data by performing one or more POR with the storage entity, wherein for sampling randomness for the POR a public source of unpredictable randomness is used, and
to verify the computed logging information.

In a further embodiment, the present invention provides a non-transitory computer readable medium storing a program causing a computer to execute a method for providing a proof-of-retrievability, ‘POR’, to a client, for data stored on a storage entity, the method including the steps of:
a) Encoding, by the client, data to be stored on the storage entity,
b) Exchanging credentials between the storage entity, the client and an auditing entity,
c) Committing, by the client, to the encoded information using data identification information,
d) Storing the encoded data on the storage entity together with the data identification information,
e) Computing, by the auditing entity, logging information for the stored data by performing one or more POR between the auditing entity and the storage entity, wherein for sampling randomness for the POR a public source of unpredictable randomness is used,
f) Verifying, by the auditing entity, the computed logging information, and
g) Verifying, by the client, the verified logging information of the auditing entity in a single batch verification procedure.

In a further embodiment, the present invention provides an auditing entity being adapted to compute logging information for stored data on a storage entity by performing one or more proof-of-retrievability, ‘POR’, with the storage entity. For sampling randomness for the POR, a public source of unpredictable randomness is used, and to verify computed logging information.

In a further embodiment, the present invention provides a client entity being adapted to encode data to be stored on a storage entity, to commit to the encoded information using data identification information, to initialize storing the encoded data on the storage entity together with the data identification information, and to verify verified logging information of an auditing entity in a single batch verification procedure.

In a further embodiment, the present invention provides method for providing a secure outsourced/delegable proof-of-retrievability, ‘OPOR’, scheme being transformed from any secure publicly verifiable POR scheme and using a public source of unpredictable randomness for sampling randomness for the OPOR and cryptographic batch verification procedures to verify POR and to verify verified POR information.

At least one embodiment may have at least one of the following advantages: Receiving higher guarantees on permanent data availability compared to today's service level agreements SLA of data storage providers. Outsourcing the verification of public POR to an independent auditor, so that no activity of the data owner is necessary. The possibility to retrieve and check the log file of the auditor at any time, to validate the work of the auditor in a single batch verification. High flexibility and applicability, for example for establishing a cyber security insurance market.

The terms “computing device”, “computing entity” or “storage entity”, “client”, “client entity”, “auditing entity”, or similar terms refer in particular in the claims, preferably in the specification each to a device or entity adapted to perform computing like a personal computer, a tablet, a mobile phone, a server, a router, a switch or the like and includes one or more processors having one or more cores and may be connectable to a memory for storing an application which is adapted to perform corresponding steps of one or more of the embodiments of the present invention. Any application may be software based and/or hardware based installed in the memory on which the processor(s) can work on. The computing devices or computing entities may be adapted in such a way that the corresponding steps to be computed are performed in an optimized way. For instance different steps may be performed in parallel with a single processor on different of its cores. Further the computing devices or computing entities may be identical forming a single computing device.

The term “computer readable medium” may refer to any kind of medium, which can be used together with a computation device or computer and on which information can be stored. The information may be any kind of data which can be read into a memory of a computer. For example the information may include program code for executing with the computer. Examples of a computer readable medium are tapes, CD-ROMs, DVD-ROMs, DVD-RAMs, DVD-RWs, BluRay, DAT, MiniDisk, solid state disks SSD, floppy disks, SD-cards, CF-cards, memory-sticks, USB-sticks, EPROM. EEPROM or the like.

The term “storage entity” refers in particular in the claims, preferably in the specification to a computing entity or computing device adapted to store data or information.

The term “data identification information” refers in particular in the claims, preferably in the specification to any kind of information or data which can be used to identity other data or information or parts of data or information stored. For example data identification information is the key and the information to be stored is the value to the key in a key value store.

The term “logging information” refers in particular in the claims, preferably in the specification to any kind of data or information which includes results or information of prior or current checks of data or the like.

The term “single batch verification procedure” refers in particular in the claims, preferably in the specification to a procedure, algorithm and/or method enabling a verification of a plurality of different information or data in one step or round, which means that for example a plurality of entries of data can be checked within a single round of verification without having the need to check each entry of data individually by performing the procedure, algorithm and/or method more than once.

The term “BLS” refers in particular in the claims, preferably in the description to the Boneh-Lynn-Shacham signature scheme.

The committing according to step c) may be performed by using a Merkle tree or using a cryptographic hash function. This allows in an easy and reliable way to ensure data integrity.

The public source of randomness may be time-dependent. This provides randomness in an easy and reliable way.

The public source of randomness may be based on Bitcoin block chain. This enables since any Bitcoin block hashes can be publically reconstructed in any point in the past and new values are unpredictable randomness to a high extent.

The same batch verification procedure may be used by the auditing entity for verifying retrievability of the data and by the client for verifying the logging information of the auditing entity such that the client uses the batch verification procedure with accumulated proofs of the auditing entity. This enables an efficient implementation of the batch verification procedure.

The data identification information may be computed in form of file tags, the file tags including one or more random elements as well as a random file name, the number of random elements corresponding to a partition of the data to be stored. The random file name may be chosen from sufficiently large domain. The file tag enables to identify the file and the file then may be published to anyone which is interested in verification.

The file tag may be a concatenation of the one or more random elements and the random file name. This allows in an easy way to provide the file tag, including of the random elements and the random file name.

The cryptographic hash function may be a BLS hash function. This allows computation of the hash function and the corresponding signature efficiently allowing shorter signatures compared with full domain hash FDH.

A pseudo-random function and/or pseudo-random permutation function may be used during the proof-of-retrievability to generate randomized coefficients and indices for parts of the encoded data to be proved to be retrievable. This allows efficiently generating challenges for the POR.

There are several ways how to design and further develop the teaching of the present invention in an advantageous way. To this end it is to be referred to the following explanation of embodiments of the invention and the figures. In connection with the explanation of the embodiments of the invention by the aid of the figures, generally further embodiments and further developments of the teaching will be explained.

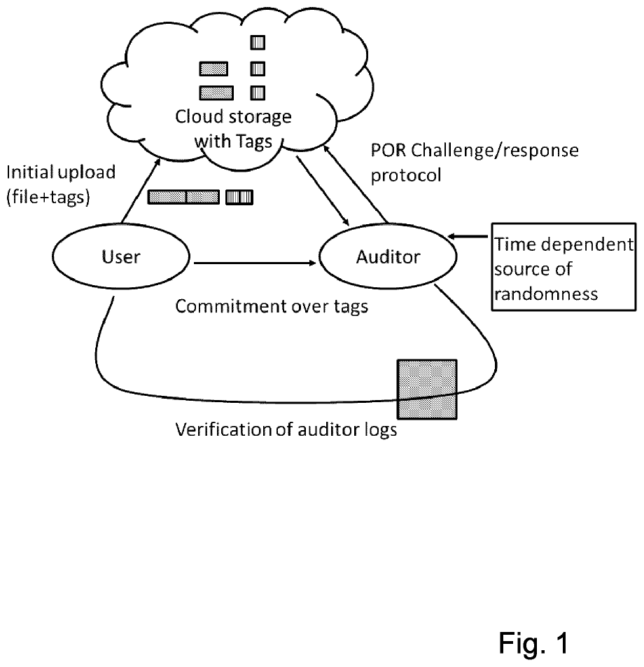

FIG. 1 shows steps of a method according to an embodiment of the present invention.

In FIG. 1 a sketch of the method according to an embodiment of the present invention is shown.

Similar to a conventional POR scenario, the following scenario is assumed: A user U, the data owner, plans to outsource his data M to a service provider S. In addition, the user U is interested in acquiring regular proofs that his data M is correctly stored and retrievable from the service provider S. Further a new entity A, called the auditor, who runs POR with the service provider S on behalf of the user U is present. If these POR do not succeed, the auditor A takes certain actions, e.g., informs the user immediately. Otherwise, the user U is assured that the data M are stored correctly.

To summarize FIG. 1, the user U first encodes the information to be stored and exchanges credentials with the auditor A and the cloud service provider S, and vice versa. The user U commits to the encoded information to be stored using tags to the auditor. The file M and the tags are uploaded by the user U to the cloud storage S. The auditor A, which uses a public source of unpredictable randomness to sample randomness of the public proof-of-retrievability, performs a proof-of-retrievability challenge/response protocol with the cloud storage provider S and computes a corresponding log file for the user U. The auditor A also verifies the correctness of the stored data M based on the result of the POR challenge/response protocol. The user U in turn then retrieves the log file and validates the verification of the auditor log file in a single batch verification procedure.

In detail, an external, time-dependent randomness source is used:

Formally, this source may be represented by a function GetRandomness(t) which takes as input a point in time t and outputs either a bitstring yϵ(0,1)ⁿ for some fixed positive integer n≥1 or ⊥. More precisely, it first checks if t refers to a point in time in the past, i.e., refers to a date before the current point in time curr assuming that the user and GetRandomness( ) are synchronized. If this is not the case, the output is ⊥. Otherwise, the output is a bitstring xϵ{0,1}ⁿ. Here, two properties need to hold:
The values GetRandomness(t) for past values t, i.e., t≤curr, can be publicly requested anytime. That is, these values can be correctly reconstructed by any party.
The values GetRandomness(t) for past values t, i.e., t>curr, cannot be predicted.

An embodiment may be based on Bitcoin and works as follows:

$$GetRandomness ( t ) = \{ \begin{matrix}⊥ if t > curr \\ {h}_{t} if t \leq curr\end{matrix}$$

Here, hₜ is the hash of the latest block that has appeared until time t in the Bitcoin block chain. As it is possible to publicly reconstruct any Bitcoin block hashes in any point in the past, the first property is met. Since a new block is on average generated every 10 minutes and is unpredictable, the second property is fulfilled as well.

In an embodiment the following procedures are used:

First, a Setup procedure is performed, which generates randomly an RSA public key pk=(N, e) and an RSA secret key sk=d. This public key pk is distributed to all parties, including the auditor A. Then a family of pseudo-random functions fk:

[symbol]

→ [symbol] _{N}, i.e., a set of functions indexed by a key is constructed, and a cryptographic hash function H:{0, 1}*→ [symbol] _{N} and these are made public.

The procedure Store (pk,sk,M) takes as input the public key pk, the secret key sk and the file M to be stored. The file M is split prior to storing into n blocks m₁, . . . , mₙ given some n, depending on the chosen block size. Each block mᵢ is then again split into s sectors {mᵢⱼ} for 1≤i≤n and 1≤j≤s such that each sector is an element of [symbol] _{N}. A random file name “name” is chosen from a sufficiently big domain, e. g. [symbol] _{N} as well as s random elements u₁, . . . , uₛϵ [symbol] *_{N}. The file tag r is then {name, n, u₁, . . . , uₛ} and will, like the public key, be made public to anyone interested in verification. Let pk=(N, e), sk=d. For each i with 1≤i≤n, then:

σᵢ←(H(name∥i)·Πⱼ₌₁^{s}uⱼ^{m}^{ᵢⱼ})^{d} mod N

is computed.

Finally, a pseudo-random permutation: {1, . . . , n}→{1, . . . , n} is set up.

The processed file M* is {mᵢⱼ}, 1≤i≤n and 1≤j≤s together with {σ₁, . . . , σₙ}. The other values and functions are stored locally by the user.

The processed file M* is then uploaded to the storage entity for storing.

For proving the retrievability of M on the storage entity, the auditor A performs the following proof procedure: Proof (pk, M*, τ, Q). This procedure includes the following steps:

In a first step, let pk=(N, e) and Q=(c, t) where c is the challenge size and t denotes a point in time agreed upon with the challenger. Initialize I=Ø. GetRandomness(t) is invoked and two keys k₁ and k₂ from the output are extracted.

For 1≤j≤c,
an index of a block to sample: i=πₖ_{₁}(j), and
a coefficient aᵢ=fₖ_{₂}(j) is computed.
(i, aᵢ) is then added to the set I containing all the indices and coefficients that depend on t.

In a second step, using the set I from step 1, and the values σᵢ contained in M* are used.

$$σ ← {\prod }_{( i , {a}_{i} ) ∈ I} {σ}_{i}^{{a}_{i}} mod N$$

In a third step, the set I from step 1. and the file sectors from M* are used and for each 1≤j≤s

$${μ}_{j} ← {\sum }_{( i , {a}_{i} ) ∈ I} {a}_{i} {m}_{ij} ∈ ℤ$$

is computed.

Then in a forth step 4.

V=(σ,μ₁, . . . ,μₛ)

is output.

To verify the result of the proof, the auditor A performs the following verification procedure: verify (pk, V, π, Q).

This procedure includes of the following steps:
1. In a first, step pk=(N,e), V=(σ, μ₁, . . . μₛ), τ={name, u₁, . . . uₛ}, Q=(c, t), I=Ø are set.
2. In a second, step k₁ and k₂ by means of GetRandomness(t) as explained above are acquired. For 1≤j≤c,
   an index of a block to sample: i=πₖ_{₁}(j), and
   a coefficient αᵢ=fₖ_{₂}(j) is computed.
      (i, aᵢ) is added to the set I containing all the indices and coefficients that depend on t.
3. In a third step, a log entry Λ:=(t, σ, μ₁, . . . , μₛ) is added.
4. In a forth step, it is checked whether

$${{σ}^{e} {=}^{?} {\prod }_{( i , {a}_{i} ) ∈ I} H ( name ) \vert \vert i )}^{{a}_{i}} \cdot {\prod }_{j = 1}^{s} {u}_{j}^{{μ}_{j}} mod$$

If so, TRUE is output, as the verification succeeded, otherwise FALSE is output.

To check the verified log-file of the auditor A, the user U then performs the following procedure: checkLog (pk,T): Let pk=(N, e), τ={name, u₁, . . . , uₛ}. To address different log entries within the log file, these are expressed by (t, α^{(t)}, μ₁^{(t)}, . . . , μₛ^{(t)}). The user U selects dates T={t₁, t₂ . . . , tₗ} for which log entries have been created according to the review level agreement and SLA sends them to auditor A. The auditor A then responds with an accumulated response:

V^{(T)}=(α^{(T)},μ₁^{(T)}, . . . ,μₛ^{(T)})

where

$${σ}^{( T )} = {\prod }_{t ∈ T} {σ}^{( t )} mod N$$

and, for 1≤j≤s,

$${μ}_{j}^{( T )} = {\sum }_{t ∈ T} {μ}_{j}^{( t )} ∈ ℤ$$

The user U will then execute the above procedure verify with the n accumulated proofs and arrive at step 4 of the procedure with the following values:

$${( {σ}^{( T )} )}^{e} {=}^{?} {\prod }_{( i , {a}_{i} ) ∈ {I}_{( T )}} {H ( name \vert \vert i )}^{{a}_{i}} \cdot {\prod }_{j = 1}^{s} {u}_{j}^{{μ}_{j}^{( T )}} mod$$

Here, I_{(T)} is defined as follows: Let for any tϵT denote by Iₜ the set of pairs (i, aᵢ) that are derived from GetRandomness(t) as explained above. Then, I_{(T)}=U_{tϵT} Iₜ is set.

In a further embodiment the SW BLS signature scheme instead of the prior SW-RSA scheme is used.

The following assumptions are made let e: G₁×G₂→G_{T} be a bilinear map and let g be a generator of G₂, and H:{0,1}*→G₁ be the BLS hash.

First again a setup procedure is performed: A random αϵ [symbol] ₚ is chosen and v←g^{α} is computed. As public key pk=v is set and as secret key sk=α. pk is distributed to all parties, including the auditor A.

For storing, the user U performs the procedure Store(pk, sk, M): Let pk=v and sk=α. The file M is split into n blocks m₁, . . . , mₙ (given some n, depending on the chosen block size). Each block is then again split into s sectors {mᵢⱼ} for 1≤i≤n and 1≤j≤s. A random file name “name” is chosen from a sufficiently large domain (e. g. [symbol] ₚ) as well as s random elements u₁, . . . , uₛϵG₁. The file tag r is then {name∥n∥u₁∥ . . . ∥uₛ} and will, like the public key, be published to anyone interested in verification.

For each i, 1≤i≤n,

$${σ}_{i} ← {( H ( name \vert \vert i ) \cdot {\prod }_{j = 1}^{s} {u}_{j}^{{m}_{ij}} )}^{α}$$

is computed.

The processed file M* is {mᵢⱼ}, 1≤i≤n and 1≤j≤s together with {σᵢ}, 1≤i≤n.

Additionally, let f:{1, . . . n}→ [symbol] ₚ be a pseudo-random function and π:{1, . . . , n}→{1, . . . , n} a pseudo-random permutation. f and i will be used to generate randomized coefficients and indices and take a key as additional input.

The auditor A then may prove the retrievability by performing proof (pk, M*, π, Q): This procedure includes of the following steps:
1. Let pk=v, Q=(c, t), and l. Derive k₁ and k₂ from GetRandomness(t) as explained above, where t is a time agreed upon with the challenger. For 1≤j≤c,
an index of a block to sample i=πₖ_{₁}(j) and
a coefficient αᵢ=fₖ_{₂}(j)ϵ [symbol] ₚ are computed
(i, αᵢ) is added to the set I including all the indices and coefficients that depend on t.
2. Then the set I from step 1 is used and the values σᵢ stored in M*. Then

$$σ ← {\prod }_{( i , {a}_{i} ) ∈ I} {σ}_{i}^{{a}_{i}} ∈ {G}_{1}$$

is computed.
3. In a third step the set I from step 1 is used and the file sectors from M*. Then for each 1≤j≤s

$${μ}_{j} ← {\sum }_{( i , {a}_{i} ) ∈ I} {a}_{i} \cdot {m}_{ij} ∈ {ℤ}_{p}$$

is computed.
4. In a fourth step

V=(σ,μ₁, . . . ,μₛ)
is output.

To verify the result of the proof the auditor performs the following verification procedure: verify(pk, V, τ, Q): This procedure includes of the following steps:
1. Let pk=(v), V=(σ, μ₁, . . . , μₛ)), τ={name, u₁, . . . , uₛ}, Q=(c, t), I=Ø.
2. In a second step k₁ and k₂ are derived from GetRandomness(t) as explained above. For 1≤j≤c,
   an index of a block to sample: i=πₖ_{₁}(j)ϵ{1, . . . , n}
a coefficient αᵢ=fₖ_{₂}(j)ϵ [symbol] ₚ are computed.
(i,) is added to the set I containing all the indices and coefficients that depend on t.
3. In a third step a log entry Λ:=(t, σ, μ₁, . . . , μₛ) is added to the log file.
4. In a fourth step it is checked whether

$$e ( σ , g ) {=}^{?} e ( {\prod }_{( i , {a}_{i} ) ∈ I} {H ( name \vert \vert i )}^{{a}_{i}} \cdot {\prod }_{j = 1}^{s} {u}_{j}^{{μ}_{j}} , v )$$

If so, TRUE is output, as the verification succeeded, otherwise FALSE is output.

To check the verified log-file of the auditor A, the user U then performs the following procedure: checkLog(pk, τ): Let pk=(N, e), τ={name, u₁, . . . , μₛ}. To address different log entries within the log file, these are expressed by (t, σ^{(t)}, μ₁^{(t)}, . . . , μₛ^{(t)}).

The user U selects some set [symbol] of indices where log entries should have been created according to the SLA and sends them to the auditor A. He responds with an accumulated response:

V^{(T)}=(σ^{(T)},μ₁^{(T)}, . . . ,μₛ^{(T)})

where

$${σ}^{( T )} = {\prod }_{t ∈ T} {σ}^{( t )} ∈ {G}_{1}$$

and, for 1≤j≤s

$${μ}_{j}^{( T )} = {\sum }_{t ∈ T} {μ}_{j}^{( t )} ∈ {ℤ}_{p}$$

The user U will then execute the verify procedure with the n accumulated proofs and arrive at step 4 in the procedure with the following values:

$$e ( {σ}^{( T )} , g ) {=}^{?} e ( {\prod }_{( i , {a}_{i} ) ∈ {I}_{( T )}} {H ( name \vert \vert i )}^{{a}_{i}} \cdot {\prod }_{j = 1}^{s} {u}_{j}^{{μ}_{j}^{( T )}} , v )$$

where [symbol] is defined as explained for the outsourced public SW-RSA which holds if all single proofs would pass the verify procedure individually.

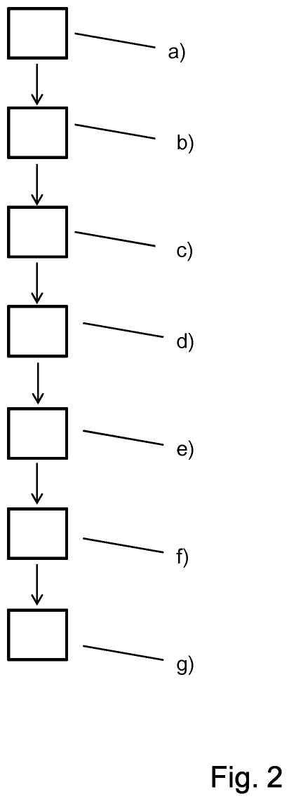

FIG. 2 shows steps of a method according to a further embodiment of the present invention.

FIG. 2 shows steps of a method for providing a proof-of-retrievability to a client, for data stored on a storage entity, performed in a memory of one or more computing devices, including the steps of:
a) Encoding, by the client, data to be stored on the storage entity,
b) Exchanging credentials between the storage entity, the client and an auditing entity,
c) Committing, by the client, to the encoded information using data identification information,
d) Storing the encoded data on the storage entity together with the data identification information,
e) Computing, by the auditing entity, logging information for the stored data by performing one or more proofs-of-retrievability, ‘POR’, between the auditing entity and the storage entity, wherein for sampling randomness for the POR a public source of unpredictable randomness is used,
f) Verifying, by the auditing entity, the computed logging information, and
g) Verifying, by the client, the verified logging information of the auditing entity in a single batch verification procedure.

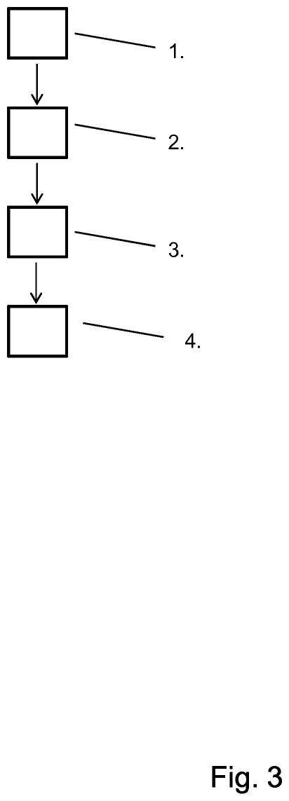

FIG. 3 shows steps of method according to a further embodiment of the present invention.

FIG. 3 shows a method for outsourcing a proof of retrievability including the steps of:
1) Encoding the information to be stored and exchanging credentials between the data owner, the storage provider and the external auditor.
2) The user commits to the encoding information by means of a Merkle tree or using cryptographic hashes
3) The auditor verifies the correctness of the stored information by producing a log file for the data owner and using a public source of unpredictable randomness to sample randomness of the public POR.
4) The data owner retrieves the log file and validates in a single batch verification the verification done by the auditor.

The present invention provides or enables a transformation of any secure publicly verifiable POR scheme into a secure outsourced/delegable POR scheme using external sources of randomness and cryptographic batch verification procedures. The present invention enables to rely on a public source of unpredictable randomness for example Bitcoin in order to prevent a verifier from misbehaving when performing a public proof of retrievability and enables an efficient batching of the verification of logs created by a verifier in order to audit the auditor.

At least one embodiment of the present invention increases the users trust into storage providers by incurring minimal user interaction. The present invention further provides enhanced flexibility and applicability, for example enables customers and external auditors to establish a contract by which customers can be assured about the security to their files.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of“or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for providing a proof-of-retrievability (POR), to a client, for data stored on a storage entity, the method performed in a memory of one or more computing devices, the method comprising the steps of:
a) Encoding, by the client, data to be stored on the storage entity;
b) Exchanging credentials between the storage entity, the client, and an auditor;
c) Committing, by the client, to the encoded information using data identification information;
d) Storing the encoded data on the storage entity together with the data identification information;
e) Computing, by the auditor, logging information for the stored data by performing one or more POR between the auditor and the storage entity, wherein for sampling randomness for the POR a public source of unpredictable randomness is used;
f) Verifying, by the auditor, the computed logging information; and
g) Verifying, by the client, the verified logging information of the auditor in a single batch verification procedure.

2: The method according to claim 1, wherein the committing according to step c) is performed by using a Merkle tree or using a cryptographic hash function.

3: The method according to claim 1, wherein the public source of randomness is time-dependent.

4: The method according to claim 1, wherein the public source of randomness is based on Bitcoin block chain.

5. The method according to claim 1, wherein the same batch verification procedure is used by the auditor for verifying retrievability of the data and by the client for verifying the logging information of the auditor such that the client uses the batch verification procedure with accumulated proofs of the auditor.

6: The method according to claim 1, wherein the data identification information is computed in form of file tags, the file tags comprising one or more random elements as well as a random file name, the number of random elements corresponding to a partition of the data to be stored.

7: The method according to claim 6, wherein the file tag is a concatenation of the one or more random elements and the random file name.

8: The method according to claim 2, wherein the cryptographic hash function is a BLS hash function.

9: The method according to claim 1, wherein a pseudo-random function and/or a pseudo-random permutation function is used during the proof-of retrievability to generate randomized coefficients and indices for parts of the encoded data to be proved to be retrievable.

10: A system for providing a proof-of-retrievability (POR) for data to a client, the system comprising:
a storage entity for storing the data of the client; and
an auditor,
wherein the client is configured to:
encode data to be stored on the storage entity;
exchange credentials with the storage entity and the auditor;
commit to the encoded information using data identification information;
initialize storing the encoded data on the storage entity together with the data identification information; and
verify verified logging information of the auditor in a single batch verification procedure,
wherein the storage entity is configured to:
exchange credentials with the client and the auditor;
store the encoded data together with data identification information;
perform one or more POR with the auditor, and
wherein the auditor is configured to:
exchange credentials with the storage entity and the client;
compute logging information for the stored data by performing one or more POR with the storage entity, wherein for sampling randomness for the POR a public source of unpredictable randomness is used; and
verify the computed logging information.

11. A non-transitory computer readable medium storing a program configured to cause a computer to execute a method for providing a proof-of-retrievability (POR), to a client, for data stored on a storage entity, the method comprising the steps of:
a) Encoding, by the client, data to be stored on the storage entity;
b) Exchanging credentials between the storage entity, the client, and an auditor;
c) Committing, by the client, to the encoded information using data identification information;
d) Storing the encoded data on the storage entity together with the data identification information;
e) Computing, by the auditor, logging information for the stored data by performing one or more POR between the auditing auditor and the storage entity, wherein for sampling randomness for the POR a public source of unpredictable randomness is used;
f) Verifying, by the auditor, the computed logging information; and
g) Verifying, by the client, the verified logging information of the auditor in a single batch verification procedure.

12: An auditor configured to:
compute logging information for stored data on a storage entity by performing one or more proof-of-retrievability (POR) with the storage entity, wherein for sampling randomness for the POR, a public source of unpredictable randomness is used; and
verify computed logging information.

13: A client entity configured to:
encode data to be stored on a storage entity;
commit to the encoded information using data identification information;
initialize storing the encoded data on the storage entity together with the data identification information; and
verity verified logging information of an auditor in a single batch verification procedure.

14: A method for providing a secure outsourced and/or delegable proof-of-retrievability (OPOR), scheme being transformed from secure publicly verifiable POR scheme and using for sampling randomness for the OPOR a public source of unpredictable randomness and cryptographic batch verification procedures to verify POR and to verify verified POR information.
